(19) United States
(12) Patent Application Publication
(10) Pub. No.: US 2002/0013735 A1
(43) Pub. Date: Jan. 31, 2002

(54) Electronic matching engine for matching desired characteristics with item attributes

(76) Inventors: Arti Arora, Los Altos, CA (US); Edward Lazear, Portola Valley, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/823,955

(22) Filed: Mar. 30, 2001

Related U.S. Application Data
(60) Provisional application No. 60/193,955, filed on Mar. 31, 2000.

(51) Int. Cl. G06F 17/60; G06F 17/30

(52) U.S. Cl. 705/26; 707/104.1; 707/5

(57) ABSTRACT

? A digital system for matching desired characteristics with item attributes. The system provides for weighting of variable values to be matched, and substitution of variables or values. Both discrete and continuous weighting can be used. This approach provides for more flexible matching to yield practical and useful results without placing high requirements on the computer system. Weights can be assigned to variable values as defaults. Such assignment is usually performed by a system administrator, or the assignment can be calculated by a process in the matching engine (e.g., as a discrete or continuous function) or otherwise automatically derived. Weights can be selected by users (both buyers and sellers) by using a user interface that translates common expressions (e.g., “not required,” “desired,” “required”) into weighting values between 0 and 1. Alternatively, users can assign weights as a number, or by other means. One feature of a preferred embodiment of the invention allows preferences (i.e., characteristics and attributes) to be matched with regard to two different sides of a transaction. For example, both buyer and seller preferences can be taken into account in creating a match. This allows sellers to eliminate items or services from a particular transaction based on seller goals of profitability, or where it makes a difference as to who the buyer is, or what is being offered in exchange for an item or service for sale. For example, in a job market system, the “seller” is an employer who may require prospective candidates to have a minimum number of years of education.

### CLAIM OF PRIORITY

This application claims priority from U.S. Provisional Patent Application No. 60/193,955 filed Mar. 31, 2000 entitled “Electronic Commerce System Including Weighted Characteristic Matching, Dynamic And Automated Creation Of Markets, Analysis Tools And Administrator Interface” which is hereby incorporated by reference as if set forth in full in this document.

### RELATED APPLICATIONS

This application is related to co-pending U.S. patent application Ser. No. [TBA], filed Mar. 30, 2001, entitled “System and Method for Implementing Electronic Markets” (Attorney Docket 20512-000120) and U.S. patent application Ser. No. [TBA], filed Mar. 30, 2001, entitled “Efficient Interface for Configuring an Electronic Market” (Attorney Docket 20512-000130).

### BACKGROUND OF THE INVENTION

This invention relates in general to digital processing and more specifically to a digital processing system for matching desired characteristics with item attributes.

One important use of electronic digital processing systems, such as computers, is to identify an item or object that is a “best match” with specified characteristics. Systems that perform such a matching function based on one or more criteria to identify a desired choice, or choices, are called “matching engines.”

An example of a matching engine is a general database query engine. A simple database query engine allows a user to specify one or more keywords and identifies documents containing the keywords. In such a system, a best match is often identified by the number of times the keywords appear in a document, the proximity of keywords to each other within a document, the placement of the keywords in different sections of a document (e.g., a title), etc. Each document may be assigned a “score” or match value. A higher score can mean that the document is a better match to the query. A list of documents can be displayed where earlier-listed documents have higher scores than later-listed documents so that the list is prioritized, making it easier for the user to identify a desired document.

More sophisticated matching engines are often used to create and facilitate “online markets.” An example of an online market is an online auto dealership where a user is asked to specify a car to be purchased. For example, a user can enter characteristics for a desired car such as the type of car, color and age of the car. A user can specify the characteristics as a “new, silver sport utility vehicle.” The matching engine will use the three desired characteristics of “new,” “silver” and “sport utility vehicle” to compare against the attributes of item entries in a database. Only those entries that include attributes matching the specified characteristics will be returned.

The prior art matching process is not without shortcomings. The number and type of characteristics that can be entered by a user are typically defined by an administrator, or operator, of the site hosting the ecommerce engine, or marketplace. The user is often constrained to using all of the predefined characteristics. Another contraint is that only the predefined characteristics may be used. That is, the user can't specify any other characteristics other than those that the administrator has provided. This means that characteristics that are important to a buyer, such as airbags for example, may never enter into the matching process. Also, characteristics that are not important to a buyer may be required by the matching engine and might be used to eliminate items in which the buyer is actually interested. A second problem is that the prior art matching process is a one-to-one correspondence matching. If a certain color is specified by the buyer the matching engine does not take into account that other colors, or even other characteristics, of the car items may be satisfactory to a buyer. This drastically limits the number of suitable matches that will be identified and presented to buyers and, hence, reduces the number of sales and amount of revenue for the participants (i.e., buyers, sellers and administrating entity) of the online marketplace.

For example, in a prior art matching engine where the buyer must answer 20 “yes/no” questions to define the desired characteristics the chances of a direct match with an item's attributes are 1 in 2²⁰ or about 1 in a million. This means that, for most applications, the number of matches will be very small, or none.

Another example is where a company has a catalog of goods having different attributes. Even companies with small catalogs (hundreds of items) can experience problems with prior art matching engines. For instance, a company may have approximately 400 types of shoes available on a website. Based on descriptions of the shoes, there may be 9 to 10 different attributes of shoes that customers care about. These attributes can include shoe style, usage (running, basketball, cross-training, etc.), price, etc. If buyers are asked to specify each of the 9 attributes as a characteristic where each characteristic has 3 choices this results in a database filter of approximately 20,000 possible combinations. Each shoe type has one set of attributes. In this case, there are 20,000 possible ‘categories’ but only 400 shoes. This implies that 19,600 categories are empty. With this matching engine approach there is a 98% chance that the search result will create no matches.

The way prior art matching engines alleviate this problem is by creating ‘or’ conditions within searches where a user can specify multiple values within each characteristic. ‘Or’ conditions can also be set up among characteristics so that all characteristics named by the user need to be present in a matching item's attributes. However, this moves the probability of a match to the other extreme. The obtains many more matches to the point where the results are not sufficiently targeted. For example, it is possible that 98% of all item entries show up as results in the search.

Thus, it is desirable to provide a matching engine that improves upon the shortcomings of the prior art and provides other advantages.

### SUMMARY OF THE INVENTION

The present invention is a computer-based system for matching desired characteristics with item attributes. The system provides for weighting of variable values to be matched, and substitution of variables or values. Both discrete and continuous weighting can be used. This approach provides for more flexible matching to yield practical and useful results without placing high requirements on the computer system.

Weights can be assigned to variable values as defaults. Such assignment is usually performed by a system administrator, or the assignment can be calculated by a process in the matching engine (e.g., as a discrete or continuous function) or otherwise automatically derived. Weights can be selected by users (both buyers and sellers) by using a user interface that translates common expressions (e.g., “not required,” “desired,” “required”) into weighting values between 0 and 1. Alternatively, users can assign weights as a number, or by other means.

One feature of a preferred embodiment of the invention allows preferences (i.e., characteristics and attributes) to be matched with regard to two different sides of a transaction. For example, both buyer and seller preferences can be taken into account in creating a match. This allows sellers to eliminate items or services from a particular transaction based on seller goals of profitability, or where it makes a difference as to who the buyer is, or what is being offered in exchange for an item or service for sale. For example, in a job market system, the “seller” is an employer who may require prospective candidates to have a minimum number of years of education.

The matching engine can be applied to many types of applications. One envisioned application is to run an electronic marketplace such as an online store, auction, reverse auction, job placement center, etc. An electronic salesperson type of market is described that focuses on cost as a key factor in matching a buyer with an item for sale.

In one embodiment the invention provides a method for matching user preferences with item characteristics in an electronic database wherein items are stored in a database along with associated attributes and values, the method comprising accepting signals from the user input device to allow a user to specify preferences in the form of attributes and values; using the processor to identify one or more matches by using a weighted comparison among at least one value in the preferences and at least one value in the database.

In another embodiment the invention provides a method for matching user preferences with item characteristics in an electronic database, wherein items are stored in a database along with associated attributes and values, the database coupled to a processor and user input device, the method comprising accepting signals from the user input device to allow a user to specify preferences in the form of attributes and values; and using the processor to identify one or more matches after performing a step of substituting one or more attributes in the preferences.

### BRIEF DESCRIPTION OF THE DRAWINGS

FIG. 1 illustrates a preferred embodiment system including the matching engine of the present invention.

### DETAILED DESCRIPTION OF THE SPECIFIC EMBODIMENTS

The matching engine of the present invention can be applied to many applications where desired characteristics are used to determine best matches of items that are described using item attributes. A preferred embodiment of the invention creates and runs different types of online markets, such as an auction, reverse auction, exchange, etc. The preferred embodiment is incorporated into a suite of software products to be manufactured and distributed by Liquid Engines, Inc. The suite of software is referred to as IXE2000 and is further described in the related patent applications, cited above.

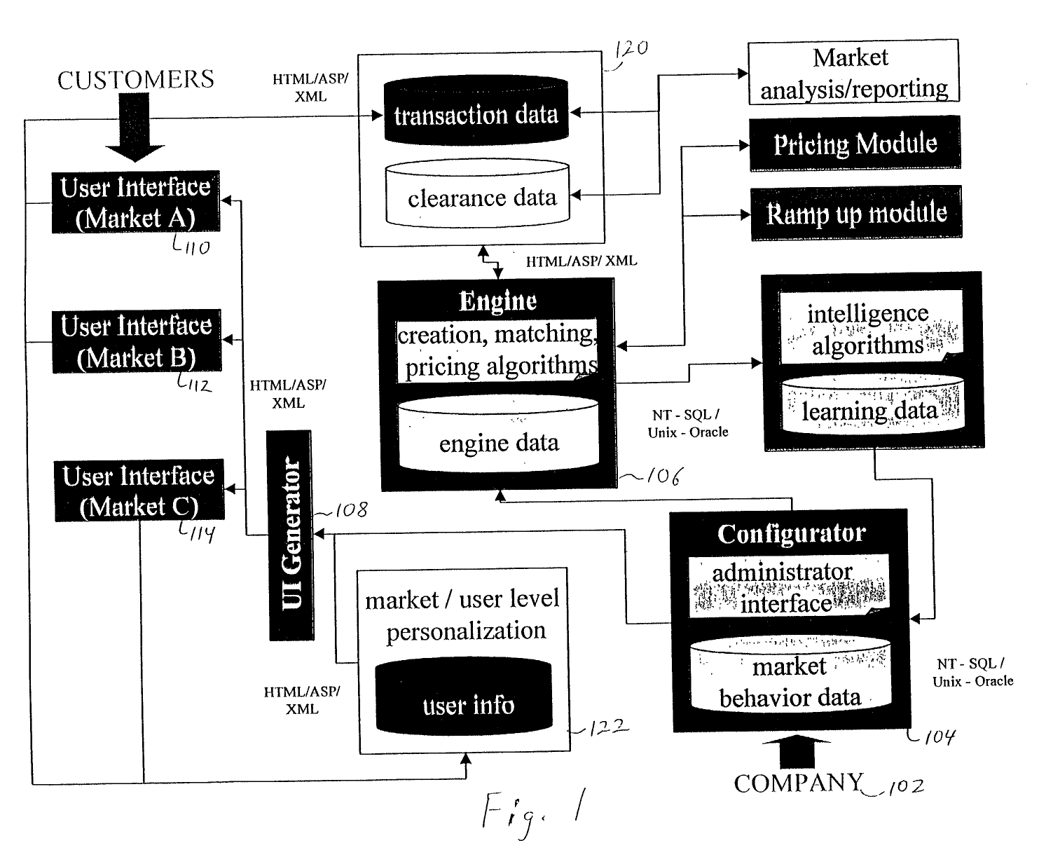

FIG. 1 illustrates a preferred embodiment system of which the present invention is a part.

In FIG. 1, company 102 uses “configurator” software 104 to create an ecommerce engine 106. Ecommerce engine 106 is used to conduct electronic commerce in specific goods and/or services and in one or more market types. Ecommerce engine 106 includes methods and processing described herein for the matching engine. Configurator software 104 includes an administrator interface and market behavior data. An administrator is a human operator who operates configurator software 104 and causes User Interface Generator software 108 to create user interfaces for buyers and sellers in different markets as shown by user interfaces 110, 112 and 114.

As buyers and sellers operate the user interfaces to characterize goods and services for sale and purchase (or trade), data is collected into databases 120 and 122 for further use by the system. The data is accessed by ecommerce engine 106 for purposes of matching goods and services to buyers. Data such as transaction data is used in analysis, pricing and creating a stable market. In some situations, there are too few traders to create stable prices in a given market. The situation is highly volatile because any one buyer or seller can have a large effect on the equilibrium price. This causes problems since traders will wait until a favorable time to trade and may even refuse to trade at a price that they previously stated would be acceptable. The situation arises most in new markets, where the case of a few traders is more common. The “ramp up” module uses a statistical approach to estimate the equilibrium price and to smooth out day-to-day variations that are not meaningful. Past data can be used to complement the limited information available as they are ramping up so that the resulting matching and pricing information is meaningful and representative of the real word market.

Market behavior and user profiles are used by the User Interface generator to create dynamic user interface screens that are personalized to the specific exchange as well as the particular user that logs in. Intelligence algorithms work in conjunction with the ecommerce engine, the various databases, and the configurator to recommend profitable, or desirable, markets to the administrator. The administrator can further model and analyze different potential markets, and can create and operate additional markets, as desired.

A preferred embodiment of the invention uses an Oracle database, XML (Extensible Markup Language), Hyper Text Markup Language (HTML) and Microsoft Active Server Page (ASP) language, tools and applications to provide a system which executes on computers connected to the Internet. However, the features and functionality of the present invention can be implemented by many other suitable means such as with other computer programming languages, protocols, architectures or design methodologies. Any type of data communication can be used such as an intranet, local-area-network, point-to-point communications, etc. The processing and interfaces of the invention can operate on any digital processing platform such as desktop computers, servers, laptop or handheld computers or processors, etc.

A preferred embodiment is described in more detail in U.S. patent application Ser. No. ______ [TBA], filed Mar. 30, 2001, entitled “Efficient Interface for Configuring an Electronic Market,” referenced, above.

As previously mentioned, the matching engine described herein is used as part of ecommerce engine 106 of FIG. 1. In this preferred embodiment, the engine is a completely flexible, fully configurable piece of software that can run virtually any kind of market. All parameters can be set by the market administrator and modified at any time. The configurator allows the market administrator to set up the market in a short period of time without any technical expertise. The user interfaces generated by the configurator enable users to access the market by answering simple questions. The engine has default settings, but is completely customizable.

The matching engine allows for substitution of characteristics. A number of attributes are defined and each attribute is then described and valued, or “weighted,” by a buyer, seller, or both. For example, an employer can specify that a desired characteristic of a recruit be that the recruit have a college degree. The employer is asked, by the interface, to specify how important the degree requirement is ranging from “essential” to “irrelevant.” Note that the language and manner used to specify the weighting can vary and is typically set by the administrator. By using the characteristic's weight, or importance, the engine is able to generate matches with potential employees and arrive at a total score which is a function of all desired characteristics and weighting levels. Note that the use of weights can also be applied to item attributes. For example, a recruit can specify that a geographic location of San Francisco is an attribute of the recruit, but the weighting can be at 50% which can mean that a San Francisco location is “fairly” desirable as opposed to being a “mandatory” requirement.

Additionally, weighting values and schemes can be set by an administrator or computed or assigned by the engine, itself. For example, a default weighting can automatically be assigned to attributes such as salary, or location. A function can be used to assign a weight to an attribute based on almost any type of criteria. An example is increasing the weighting of a salary attribute in relationship to a prospective employee's geographic proximity to a job's location that is specified as a desired characteristic.

Note that by using the matching engine of the present invention, both sides' (employers' and recruits') preferences can be taken into consideration. An advantage to this is that a potential employee does not need to be shown job positions which are desirable based on the potential employee's specified characteristics, but which are eliminated because of the employers' stated desired characteristics with respect to the recruit.

Matching in the present invention can be continuous in addition to being graduated, or “binary” (i.e., a match or no match). To use the above example, most cars neither match a buyer's desires perfectly nor not at all. Each potential buyer/seller match is valued. That match value becomes the basis on which all markets are run and all matches are made.

There is no limit to the number or types of attributes that can be used. The function allows for any finite number of characteristics. The probability of a match is not reduced by specifying more categories as would be the case in a prior art discrete matching approach.

Many market forms that were previously impractical are made possible by the engine. The different types of market forms are discussed in the related applications, referenced above.

An example of the matching engine's weighting and substitution properties is next presented, followed by a mathematical description of the matching process.

Weighting and Substitution

An example of an ecommerce market uses a matching of prospective car buyers' desired characteristics with dealers' car attributes stored in a database. An administrator designs a buyer interface that allows a buyer to define characteristics of color, type, age and other features of a desired car.

The characteristics can be input in a variety of ways. In a simplest format, the buyer merely answers “yes” or “no” to questions such as whether tilt steering, power windows, airbags, etc., must be present in the car. Other characteristics can be specified with a multiple-choice menu selection by the buyer such as the color of the car as “red,” “blue,” etc. Other characteristics may require a numerical input that can range continuously over many possible values such as the existing mileage of the car, and its horsepower.

Along with specifying the characteristics, the buyer is permitted to specify the importance of a characteristic. In a preferred embodiment, the importance value, or weight, of a characteristic, or attribute, ranges from 0 (ignore the characteristic) to 1 (the characteristic must be present in the match and must match exactly). For example, the buyer may assign an importance rating of 0.9 which could mean that the characteristic is very important but not essential.

Typically, the administrator designs a buyer interface so that a buyer need not be absolutely mindful of the weightings. This is accomplished by providing default, or automatically calculated, weights in some cases and by providing mappings of weights to common words or expressions in other cases. An example of an automatic weighting is a weighting of 0 given to those characteristics that the buyer omits, or fails to specify. For example, if the buyer does not reply “yes” or “no” to a “tilt_steering” characteristic specification then a weight of 0 can be assigned to the “tilt_steering” characteristic so that it is ignored in the matching process. Alternatively, a default non-zero importance, or weight, can be assigned to a characteristic that is omitted by the user. For example, the weight of the characteristic to an average user (statistically predefined) can be assigned when the weight is not specifically provided by the user. Another example of default weighting is where the buyer selects a value for a characteristic but fails to provide a weighting. For a color characteristic the default can be 0.3 when the buyer fails to specify a weighting since most buyers who fail to make color mandatory, or highly desirable, probably don't care too much about the color. For a car type characteristic a likely default would be 1 since car type (e.g., sedan, convertible) is usually an important, inflexible, characteristic for most buyers.

Other weightings can be calculated by the matching engine, or another process in the ecommerce system, based on a specified characteristic, multiple characteristic, or external data or factors. For example, the default weighting for a full-size spare tire can be higher where the buyer specifies an off-road vehicle type as opposed to an economy coupe.

The matching engine can act to translate, or modify, buyer-specified weightings. Typically a buyer will not be asked to input a numeric value in the range of 0-1 but can specify the weighting by using common expressions such as “not required,” “not important,” “desired,” “very important” and “required.” These expressions can be mapped to numeric weightings such as 0, 0.3, 0.5, 0.9 and 1, respectively.

The matching engine can substitute characteristics and attributes. For example, where a buyer specifies several safety devices such as front and side air bags, the engine can substitute an overall safety rating and give higher-rated cars higher scores for the safety-rating attribute. The engine can convert buyer-specified characteristics such as a “red” color into a numerical representation of the color such as a light wavelength, hue classification, etc., so that colors are matched on a continuous scale where dark orange colors result in a higher color attribute score than blue, or shorter-wavelength colors.

The matching engine can use discontinuous functions to perform attribute value matching such as where a buyer specifies that a car be “new.” The matching engine can be configured to deem “new” cars as those cars with logged mileage under 100 or some other fixed number. “Average” and “old” cars ages can be defined where each definition is a range of miles. Alternatively, a continuous function can be used where the higher the number of miles, the lower the score for the “age” attribute, or characteristic. In general, the matching engine can use any type of function including discrete, continuous, limited set (e.g., based on alphabet values), etc., to describe variables and weightings. This eliminates the need to reduce the number of variables in a search to avaoid ending up with no matches. For example, where a typical automobile marketplace might ask a prospective buyer whether the desired auto should have “less than 20,000 miles” or greater than 20,000 miles, the present invention can accept the mileage as any number and use an appropriate continuous function to achieve matching. This is discussed in more detail, below.

The matching engine can accept characteristics from a buyer that are not predefined in the engine. For example, one type of user interface can allow a buyer to specify a keyword, value and weighting using alphanumeric characters such as “sunroof=yes 1” or “supercharger=yes 0.5” or “age=before 1935 1”—indicating the attribute, value and weighting. Similarly, the car dealer specifications of available cars—in the form of records in the ecommerce database—allow dealers to add attributes, values and weightings in a similar manner. If the same attribute names are used the attributes and characteristics can be matched in the same way as for pre-defined attributes.

TABLE I

| | Value | Weight | Value | Weight | Value | Weight | Value | Weight | Value | Weight |
|---|---|---|---|---|---|---|---|---|---|---|
| Variable | buyer 1 | buyer 1 | buyer 2 | buyer 2 | seller 1 | seller 1 | seller 2 | seller 2 | seller 3 | seller 3 |
| Color | Blue | .6 | Red | 1 | Blue | 0 | Green | 0 | Black | 0 |
| Type | . . . | | | | | | | | | |
| Mileage | 10000 | .8 | 20000 | .2 | 23147 | 0 | 10932 | 0 | 15578 | 0 |
| Gas | . . . | | | | | | | | | |
| mileage | | | | | | | | | | |
| # doors | | | | | | | | | | |
| Make | | | | | | | | | | |
| Style | | | | | | | | | | |
| Location | 94028 | .9 | 94305 | .2 | 94303 | 0 | 95129 | 0 | 94025 | |
| (zip | | | | | | | | | | |
| code) | | | | | | | | | | |
| Year | | | | | | | | | | |
| . . . | | | | | | | | | | |
| . . . | | | | | | | | | | |
| . . . | | | | | | | | | | |
| . . . | | | | | | | | | | |
| . . . | | | | | | | | | | |
| Date of | Jan 3, | .9 | Feb 7, | .8 | Feb. 10 | .9 | Jan 2, | .1 | March 23, | .9 |
| delivery | 2001 | | 2001 | | | | 2001 | | 2001 | |
| (desired | | | | | | | | | | |
| if buyer | | | | | | | | | | |
| or actual | | | | | | | | | | |
| if seller) | | | | | | | | | | |

The records in Table I illustrate the previously mentioned aspects of the matching engine.

In Table I, buyers 1 and 2 have a set of desired characteristics in a car that they want to purchase. Sellers 1, 2 and 3 (which may be different sellers or different cars of the same seller), also attach a weight to each characteristic (either verbally or numerically).

For example, buyer 1 wants a blue car and seller 1 has a blue car. Thus, they match perfectly on this attribute, getting a score of 1. Buyer 1 attaches a weight to this of 0.6. (E.g., he might have answered that color was “somewhat important” which the engine transforms according to previous instructions into a numerical value. Alternatively, the buyer could have merely reported a numerical value.) Color is a discrete variable in this example since it must be one of only a relatively few values. Note that seller's weight is zero, because he does not care about buyer's preferences over color, whereas the buyer cares about the actual color of the car.

Mileage is a continuous variable where less is better. Buyer 2 prefers a car with about 20,000 miles, but fewer miles are better and more are worse. This is a continuous variable so a car with 10,000 miles receives a higher score on this attribute than one with 40,000 or even 20,000. The 20,000 response by the buyer benchmarks the function to be used in the tradeoff. Note also that buyer 2 is quite flexible on mileage, giving it a weight of only 0.2. Buyer 2 views Seller 2 best on this characteristic and seller 1 worst. Buyer 1 has the same ranking as buyer 2, but places heavier weight on this characteristic. Note that the engine does not treat all cars with, say, less than 20,000 miles the same. Those with 10,000 are a better match than those with 18,000.

Location is entered as a zip code. But the issue that it corresponds to is “how close is the dealership to the buyer's house.” Thus, distance between buyer and seller is a transformation of two zip codes, which depends on an absolute value (since distances are always positive). Buyer 1 cares a great deal about distance to the dealership; sellers 1 and 2 do not care about distance to the buyer. Seller 3 places a slight weight on distance to buyer, because that seller plans to deliver the car to the buyer's home.

Finally, date of delivery is a continuous variable that is transformed from the actual date desired. The closer to the desired date the better, but too early might be just as bad as too late because the buyer might not have the funds to purchase the car. Similarly, sellers have preferences over delivery dates as well. Sooner may be better because the seller does not have to cover holding costs. Later may be better because the seller will have more time to acquire and service the car. The ability to allow users to specify preferences is provided by the administrator and user interfaces of the present invention as discussed in the related application, referenced above. Any specified preferences or characteristics can also have an attached weight, as well.

The above examples illustrate the types of variables that can be accommodated. The approach of using weights with values can be generalized to any kind of characteristic, attribute, property, preference, data, etc. that can be transformed into a value.

The weighting function can handle any finite number of attributes, still providing non-zero matching values as long as a match does not violate an absolute restriction (e.g., when a non-matching value is discrete and its weight is 1). Conversely, no matter how good the match on, say, 999 of 1000 attributes, a score of zero results when at least one party to the match says that there must be a perfect match on one discrete attribute and the attributes do not match.

The quality of the match between buyer 1 and seller 1 depends on both the quality of the match on any given attribute and its importance. In particular, it satisfies the property that there can still be a good match when buyer and seller disagree on a characteristic, but the characteristic is deemed to be irrelevant (or almost irrelevant) to the parties.

Using the example records in Table I, the matching engine compares characteristics values and weightings for each pair, triplet, or any number of agents with all other values in the database. A mathematical description of the matching process is provided in the next section below. Descriptive examples of the matching process are provided in the following paragraphs.

To achieve a total match score for any given party to a match, two records are chosen, e.g. the record of the worker who is shopping for a job and one of the many potential employers who are shopping for workers. Then the matching engine calculates the value of the match on each attribute, the weight on each attribute and then takes a linear or non-linear function of the attributes and weights to compute a score. That score in this example is the worker's view of the quality of the match with the seller in question.

The function that combines attributes and weights to obtain a score that rates the quality of the match to one of the parties can have any form. However, in the preferred functional form, given below, there is a linear and non-linear part combined with a power function that normalizes results.

After each party's view of the match is calculated, an overall match score for a pair of agents is computed as a function of each party's score. In the example above, there would be a score that relates the worker's view of the match with the employer in question. But there is also that employer's view of the match with the worker in question. Both are taken into account to get the overall match score. In this way, the algorithm allows for the value of a match to be a function of both the buyer's view of the seller as well as the seller's view of the buyer. Any function can be used to combine buyer score with seller score. In the preferred method described below, it is the square root of the product of the score for agent i and score for agent j, but it need not be restricted to that function.

Sometimes, one attribute makes sense for one side, but not for another. For example, a firm might care about a worker's education, but not the reverse. Then, the weight for the worker's view of that attribute is zero, and the firm's weight is between 0 and 1. Sometimes the reverse is true and sometimes both hold. For example, a person trying to buy a shoe on a web site cares about color, but not how much profit the firm earns on the sale of the shoe. The firm cares about profit, but not the color of the shoe since all shoe colors may cost the same to produce. In that case, the attributes that matter to the firm receive positive weights in the firm's scoring, but zero weights in the buyer's scoring. Those that are of concern to the buyer receive positive weights in the buyer's scoring, but zero weights in the firm scoring. This can be done behind-the-scene as a default setting in the configurator or it can be entered explicitly by the users.

Default weightings, weighting substitution, weighting calculation as a function of elements in a database and user input and attribute substitution can all be dealt with. Furthermore, missing attributes can be dealt with in a number of ways. For example, a potential car purchaser might leave the “color’ field blank. The weighting can then be set to zero (indicating that the user does not care about this attribute) or other rules can be used, e.g., assigning the mean or modal value to the attribute and the mean or modal weight.

The algorithm can report matches when a criterion level is met or can report all matches in order of their quality. The criterion level can be computed as a number or a function of other data in the database or can be specified directly by the users.

It should be apparent that the matching engine of the present invention can be used in various applications that would previously suffer from the shortcomings of prior art systems in handling “many-to-many” matching problems with many attributes. The matching engine of the present invention allows these problems to be solved and computed more quickly.

The matching engine can be used advantageously in diverse applications such as (1) assigning 1000 idiosyncratic consultants to 10,000 clients each with different preferences so as to maximize profits, overall value of matches or other criteria; (2) assigning flight attendants to flight slots; (3) assigning nurses with predefined qualifications and availability to patients with specified needs; (4) assigning resources to departments, etc.

Some of the features that the matching engine is capable of providing are shown in Table II. Various embodiments and variations of the matching engine can provide one or more (including all) of the features of Table II, below.

TABLE II

| | |
|---|---|
| 1. | If characteristic x is essential to agent A, then A views every match |
| | with a party not possessing characteristic x to be unacceptable. |
| 2. | If characteristic x is more important to agent A than to B, then A |
| | values every match with a party possessing characteristic x to be no |
| | worse than B views it. |
| 3. | If agent A cares more about characteristic x than agent B, then A |
| | views a match with another agent who possesses characteristic x as |
| | being no worse than agent B views that match (other factors |
| | constant). |
| 4. | An agent who does not care about any attributes views a match with |
| | anyone as perfect. |
| 5. | The value of a match must be able to depend on the value to both |
| | sides of the transaction. |
| 6. | An agent who cares about attributes does not necessarily view a |
| | match with an agent who does not care about any attributes as |
| | perfect. |
| 7. | False negatives should not be increased as the number of attributes |
| | increases. |
| 8. | False positives should not increase in the number of attributes. |
| 9. | Continuous descriptors must be able to be handled. |
| 10. | Any functional form of attributes should be able to be handled. |
| 11. | Keywords should be able to be handled. |
| 12. | Any finite number of descriptors must be able to be handled. |
| 13. | Many to many problems must be able to be handled. |
| 14. | If buyer A's characteristics are closer to those desired by the seller |
| | than buyer B's, then the seller's view of a match with A cannot be |
| | worse than the seller's view of a match with B. |
| 15. | If seller A's characteristics are closer to those desired by the buyer |
| | than seller B's, then the buyer's view of a match with A cannot be |
| | worse than the buyer's view of a match with B. |
| 16. | If characteristic x is irrelevant to agent A, then changes in the value |
| | of x cannot affect the value of the match to agent A. |

Mathematical Specification of the Engine

First, a set of attributes that are important in determining the value of a match between buyer and seller is defined. These attributes can take a variety of forms such as being discrete (e.g., in an occupation or not), continuous (e.g., level of education), an input to another variable (e.g., zip code), etc. From these attributes the key variables are formed in the model according to a number of possible methods, depending on the type of variable. The importance of each attribute is ranked on a scale from zero to 1 which can correspond to irrelevant to essential, completely flexible to completely inflexible, or other verbiage depending on the context of the variable in question. The importance is assigned to air meaning the importance that seller i attaches to attribute r or aⱼᵣ meaning the importance that buyer j attaches to attribute r.

From the input variables, called Xᵢᵣ meaning the rth attribute for individual i (a seller) or Xⱼᵣ, where j is the index for a buyer, Dᵢⱼᵣ are created which are variables that go from zero to 1, depending on how well a buyer's desires are satisfied by a seller's characteristics (or vice versa). The value that seller i attaches to a particular match is then

$${Z}_{ij}^{i} = \sqrt{{[ {\prod }_{r} ( 1 - {a}_{{i}_{r}} ( 1 - {D}_{ijr} ) ) ]}^{\frac{1}{R}} [ {\sum }_{r} {δ}_{ir} ( 1 - {a}_{{i}_{r}} ( 1 - {D}_{ijr} ) ) ]}$$

where R is the total number of attributes indexed by r, Dᵢⱼᵣ is the value of the match between seller i and buyer j on attribute r and

$${D}_{ijr} = max [ 0 , ( 1 - \frac{{C}_{ijr}}{{C}_{r}^{max}} ) ]$$

or

$${D}_{ijr} = max \{ 0 , min [ ( \frac{{x}_{ir} - {C}_{min}}{{C}_{r}^{bliss} - {C}_{min}} ) , 1 ] \}$$

or

Dᵢⱼᵣ={0,1}

or

$${D}_{ijr} = \frac{exp ( b ( {x}_{ir} - {x}_{jr} ) / {σ}_{r} )}{1 + exp ( b ( {x}_{ir} - {x}_{jr} ) / {σ}_{r} ) }$$

depending on the context. Here, Cᵢⱼᵣ is a constructed variable based on a table look up or some other procedure. C₁ⱼᵣ is defined to be non-negative. Furthermore, the best value of Cᵢⱼᵣ is zero. All positive values are worse. For example, Cᵢⱼᵣ could be defined as distance between two locations or C₁ⱼᵣ max is the max tolerable value. All values greater than this should give the calculated Dᵢⱼ a value of zero.

In one form of D, the parameter b is set by the market administrator. For example, if b=1.946, then the logistic function shown is such that 2 standard deviations out gives a value of 0.98 or 0.02, depending on a negative or positive value.

Other functional forms for the calculation of D₁ⱼᵣ are shown below:

$${D}_{ijr} = max \{ 0 , min [ 1 , 1 - \frac{\vert {X}_{ir} - {X}_{jr} \vert}{2 \cdot {X}_{half , r}} ] \}$$

$$or$$

$${D}_{ijr} = max \{ 0 , min [ 1 , 1 - \frac{1}{2} {( \frac{{X}_{ir} - {X}_{jr}}{{X}_{half , r}} )}^{2} ] \}$$

$$or$$

$${D}_{ijr} = max \{ 0 , min [ 1 , 1 - \frac{1}{2} \sqrt{\frac{\vert {X}_{ir} - {X}_{jr} \vert}{{X}_{half , r}}} ] \}$$

where X_{half,r} is the mean or median value of X for that attribute in the sample. These provide linear, concave and convex functions in X that have upper and lower supports.

Although the algorithm supports other possible functional forms for D, most of forms necessary for matching are described by those shown above. All this requires is that the market administrator is judicious in the choice and definitions of the X variables.

What can be done for seller i can also be done for buyer j so that a Zᵢⱼⁱ can be defined as above. Then, the match value is

$${Z}_{ij} = {( {Z}_{ij}^{i} {Z}_{ij}^{j} )}^{1 / 2} .$$

This method guarantees that there is always a best match. The quality of the match can be relatively good or relatively poor, but there is no doubt that a best match can always be found, simply defined as the highest Zij for any given seller i or buyer j. Unlike the categorical approach, increasing the number of variables does not diminish the probability of finding a match. More variables means a more detailed description of what is a good match, but this may be improved or weakened by adding more attributes.

Once the match values are calculated, they can be used to put together markets. Examples of possible markets are described in the above-referenced related patent applications. Possible markets include Goods Exchanges, Service Exchanges, Competitive Markets, Modified Competitive Markets, Consignment Stores, Barter, Electronic Pawnshops, Trading Posts, Qualified Auctions, Forward Contracts, Futures and Credit Markets, Electronic salesperson and Internal Allocation.

Properties of a specific ecommerce market, such as the price at which goods are sold, can be set in a variety of ways and are not specific to the engine. Each market can use a variety of match algorithms and number of matches. For example, a buyer might want to see m sellers and a seller might want to see n buyers. Each match can be priced (so that the exchange gets a commission for each match), fees can be charged on the basis of actual trades that occur or a subscription fee can be charged.

Transaction data is entered into the ecommerce system. For example, where the market is a job market, job seekers specify attributes and values regarding their qualifications, location, etc. A prospective employer can enter desired characteristics of candidates in the form of attribute/value pairs, also. The attribute/value (a/v) pairs can receive a weighting that is used in the matching engine process as described above.

Another example of a market is an exchange where User_1 is a provider of item_A and seeks to obtain item_B. Both item_A and item_B are described using a/v pairs with optional weightings. User_1's item_A is matched to the desired items of other users in the market. Likewise, User_1's item_B is matched to provided items of other users in the market. The matching procedure can be designed to provide only the best single exchange between two users, or can be used to resolve (or “clear”) item exchanges among all users, or a subset of all users. For example, the ten best matches can be presented to the users for acceptance. The entity running the ecommerce marketplace can obtain a commission on completed exchanges.

In fact, the two agents need not be a buyer and seller at all. For example, the “buyer” could be a route that electricity could follow and the “seller” could be a particular bundle of electrical power that is ready to be transmitted. The matching capability allows for any two or more agents or entities to be matched with one another.

Electronic Salesperson

Another type of market is a simple “salesperson” market where buyers provide desired characteristics of an item to be purchased. The desired characteristics are matched to item attributes. One important property of the salesperson market is that the buyer is allowed to state a price that the buyer is willing to pay. Price consideration is important since, unlike many other characteristics, it will often be the pivotal characteristic upon which the sale hinges. The seller's position on price is taken into consideration so that sellers (or item providers) can be assured of obtaining an optimal, desired, or at least minimum profit.

The salesperson application is similar to the discussion, above, for Z₁ⱼ. Zᵢⱼⁱ is the buyer side and is defined using the relevant characteristics including a Dᵢⱼ for price, where Dᵢⱼ price is defined as

$${D}_{ijr} = \frac{exp ( 1.946 ( {x}_{ir} - {x}_{jr} ) / {σ}_{r} )}{1 + exp ( 1.946 ( {x}_{ir} - {x}_{jr} ) / {σ}_{r} )}$$

where xij is the price that the consumer states that he expects to pay, xⱼᵣ is the price of the article in question and σᵣ is the standard deviation of the bid prices for consumers. On initial setup, before any data are available, estimate σᵣ by the standard deviation of the (unweighted or weighted by sales volume) selling prices of the items in the market.

The slight deviation is that on the seller side, Zᵢⱼ¹ can be constructed as it normally is, but there is an alternative.

A firm wants to maximize expected profit by offering the good, j, that maximizes the following: max {(prob buys good_1)(profit on good_1), (prob buys good_2)(profit on good_2), . . . (prob buys good_j)(profit on good_j)}.

Initially, Zᵢⱼⁱ can be used as an estimate of square of prob buys 1. Later (see below) use market data to estimate logit where Dᵢⱼᵣ and aᵢᵣ are right hand variables (using functional form in the Z function). Then Zᵢⱼ^{j} is just the square of the profit made on good j.

Since everything will be ordinal, Z₁ⱼ can be normalized to between zero and one by defining

? Z₁ⱼ^{j}=[( [symbol] ⱼ− [symbol] ₘᵢₙ)/( [symbol] ₘₐₓ− [symbol] ₘᵢₙ)]²

where [symbol] ⱼ is the profit on good j, [symbol] ₘₐₓ is the maximum profit on all goods in the set, and [symbol] ₘₐₓ is the minimum profit on all goods in the set.

After the market is created, there will be data on buyers' purchases. With the purchase data, a logit is run where the r.h.s. variable is Zᵢⱼⁱ. Then for next round, redefine

Z₁ⱼⁱ as Prob(Zᵢⱼⁱ)

where Prob(Zᵢⱼⁱ) is the predicted probability from the logit, given Z₁ⱼ.

An alternative is to run the logit where the rhs variable is not Zᵢⱼⁱ, but instead, the vector of

(1−aᵢ_{ᵣ}(1−Dᵢⱼᵣ))

and to use the coefficients on the logit to get a predicted probability. Then the Z₁ⱼ¹ is simply the predicted probability of sale from the logit, where the a and D data are entered by the user. This is probably the better approach, although the fit of the logit (−2 log likelihood) will tell us.

The price should not be taken as given. Instead, marginal cost of the item should be given as data rather than the profit per item. Could solve the problem by calculating the profit maximizing price for each of the j items and then offer the one at the price (e.g., list minus the calculated discount) that maximizes profit across all items.

A numerical approximation should work quite well. Take list price on good j. Then calculate (list price−marginal cost). Calculate the probability of a sale for good j based on prices that vary from list price down to marginal cost in h increments, i.e.,

prob of sale as function of attributes and price where price=list price−(g/h)(list price−marginal cost) for g=0 to h

(actually could do it for g=0 to h−1 because g=h yields zero profit).

Then pick the price for good j that maximizes (prob of sale)(price−marginal cost). Do this across all goods j and show the highest profit good or goods in order of their expected profit with discounts offered so that the purchase price is the optimal price for that good.

Note that an analagous type of computation can be performed for the advantage of the buyer. The buyer is typically not interested in profit margin—but only in ultimate price. In the buyer case, prices of all goods j are compared while taking into account discounts, regional taxes, promotional offerings, etc., to minimize the ultimate price.

A preferred embodiment shows up to 3 offerings. The offerings can be made dynamic so that the displayed offerings, or possible buyer choices, are changed periodically based on real-time gathering and computation of market data. If changes in market data create price differences among the offerings that disfavor the seller (or, alternatively, disfavor the buyer) then offerings can be removed (or added). For example, if the expected profit from best to second best choice falls off too dramatically, i.e., exceeds some critical value (or function), then only one choice can be shown. Similarly, the same approach can be taken among all offerings such as between offerings 2 and 3, etc.

Note that the present invention allows sellers to “push” products that they prefer to sell. For example, if a buyer prefers item A over item B, but item B's sale would yield a higher profit for a seller, the matching engine can be set to offer item B and not item A.

Although the invention has been described with respect to specific embodiments thereof, these embodiments are merely illustrative, not exclusive, of the invention. For example, the matching engine has been discussed by using the terms “desired characteristics” and “item attributes.” However, these terms are functionally equivalent so that the notions of “characteristics” and “attributes” can be interchanged throughout the discussion, herein. The term “characteristics” has been used to indicate attributes that a user specifies to search for a match among stored items in a database. The term attributes has been used to describe traits of items to match with the characteristics. However, the engine can match stored item attributes with stored item attributes (as where two databases of items are compared); specified characteristics with specified characteristics (as where two groups of users indicate preferences and the preferences are matched), etc.

The principles of price and offering in the “Electronic Salesperson” section can be applied to markets other than the “salesperson” market. All of the various features and computations of the invention need not be present in a given system. Also, additional features can be employed to supplement the features presented herein without departing from the scope of the invention.

Any manner of hardware and software can be employed to achieve the present invention. Although a preferred embodiment of the invention uses client computers coupled to one or more server computers via the Internet, other approaches include using a local-area network or standalone system. A dedicated network can be used, or a single machine can be used to provide all of the processing and user interfaces. For example, a multi-user time-shared environment where users access a single computing machine can be used. Other approaches are possible.

The matching engine and associated components and processing can be distributed over several digital processing, or digital handling, hardware components and software processes. The design of hardware and software can vary widely.

Many techniques can be employed to identify matches, assign weightings, interpolate weightings, etc. For example, complementary slackness approaches, such as epsilon complementary slackness, can be used to assist in determining matches. Note that not all of the techniques and steps described herein need be employed in any given matching engine. A subset of the steps, features, or characteristics of the matching engine of the present invention can be employed, as desired. Additional steps, or processing, can be used in conjunction with those presented, herein.

Thus, the scope of the invention is to be determined solely by the appended claims.

What is claimed is:

1. A method for matching user preferences with item characteristics in an electronic database, wherein items are stored in a database along with associated attributes and values, the database coupled to a processor and user input device, the method comprising
accepting signals from the user input device to allow a user to specify preferences in the form of attributes and values;
using the processor to identify one or more matches by using a weighted comparison among at least one value in the preferences and at least one value in the database.

2. The method of claim 1, further comprising.
using a continuous weighting comparison.

3. The method of claim 1, further comprising.
using a discontinuous weighting comparison.

4. The method of claim 1, further comprising.
using a linear weighting comparison.

5. The method of claim 1, further comprising
using a non-linear weighting comparison.

6. A method for matching user preferences with item characteristics in an electronic database, wherein items are stored in a database along with associated attributes and values, the database coupled to a processor and user input device, the method comprising
accepting signals from the user input device to allow a user to specify preferences in the form of attributes and values;
using the processor to identify one or more user matches by using a weighted comparison among at least one value in the preferences and at least one value in the database;
using the processor to identify one or more item matches by using a weighted comparison among at least one value in the database and at least one value in the preferences; and
informing the user of best matches, wherein the best matches include at least one match from the one or more user matches and at least one match from the one or more item matches.

7. The method of claim 1, wherein the step of using the processor to identify one or more matches includes substeps of
identifying matches by deriving a value from the weighted comparison, wherein values indicate a range of matches from strong to weak; and
using a condition to identify a match, wherein the condition results in a match being identified where the match is not the strongest match.

8. The method of claim 7, wherein the condition includes a consideration of a profit margin in completing a transaction based on the identified match, the method further comprising
selecting the match that results in the highest profit margin.

9. The method of claim 1, further comprising
indicating the one or more matches to a user.

10. The method of claim 1, further comprising
initiating a transaction based on the one or more matches.

11. The method of claim 1, wherein an attribute has multiple selections per attribute.

12. The method of claim 1, wherein items are goods.

13. The method of claim 1, wherein items are services.

14. A method for matching buyer preferences with characteristics of items being sold in an electronic marketplace, the method comprising
accepting input from buyers to define buyer preferences as attribute/value pairs;
storing definitions of items as attribute/value pairs; and
using weighting information with the attribute/value pairs to match buyer preferences with item characteristics by deriving a score for a match.

15. The method of claim 14, wherein different weighting information is associated with two or more item characteristics.

16. The method of claim 14, wherein different weighting information is associated with two or more buyer preferences.

17. A method for generating a score for the strength of a match between first and second sets of attribute/value pairs, the method comprising
deriving a first score to indicate the strength of a match of the first set to the second set; and
deriving a second score to indicate the strength of a match of the second set to the first set, wherein the first and second scores are not the same.

18. The method of claim 1, wherein an attribute is the time at which an event occurs.

19. The method of claim 17, wherein the time attribute has a range of values.

20. The method of claim 1, wherein a location attribute is used to indicate location, the method further comprising
computing the absolute difference between locations specified by first and second location attributes;
using the absolute difference in identifying one or more matches.

21. The method of claim 1, wherein attributes can have continuous values.

22. The method of claim 20, wherein an attribute represents education in years.

23. The method of claim 20, wherein an attribute represents size.

24. The method of claim 20, wherein an attribute represents weight.

25. The method of claim 1, further comprising
transforming a first value associated with a first attribute into a second value associated with the first attribute, wherein the second value is used in place of the first value to identify one or more matches by using a weighted comparison.

26. The method of claim 1, wherein the user designates multiple attributes and values to specify a preference.

27. The method of claim 1, wherein the step of using the processor to identify one or more matches includes the step of
using epsilon complementary slackness to identify the one or more matches.

28. The method of claim 1, further comprising
performing a subsequent matching operation after removing preferences and characteristics of the one or more identified matches.

29. A method for matching user preferences with item characteristics in an electronic database, wherein items are stored in a database along with associated attributes and values, the database coupled to a processor and user input device, the method comprising
accepting signals from the user input device to allow a user to specify preferences in the form of attributes and values;
using the processor to identify one or more matches after performing a step of
substituting one or more attributes in the preferences.

30. A method for matching user preferences with item characteristics in an electronic database, wherein items are stored in a database along with associated attributes and values, the database coupled to a processor and user input device, the method comprising
accepting signals from the user input device to allow a user to specify preferences in the form of attributes and values;
using the processor to identify one or more matches after performing a step of
substituting one or more attributes in the characteristics.

31. A method for matching user preferences with item characteristics in an electronic database, wherein items are stored in a database along with associated attributes and values, the database coupled to a processor and user input device, the method comprising
accepting signals from the user input device to allow a user to specify preferences in the form of attributes and values;
substituting one or more attributes in either the characteristics or the preferences; and
subsequent to the step of substituting, performing the step of using the processor to identify one or more matches by using a weighted comparison among at least one value in the preferences and at least one value in the database.
